(19) United States
(12) Patent Application Publication
(10) Pub. No.: US 2010/0230471 A1
(43) Pub. Date: Sep. 16, 2010

(54) BONDING METHOD AND BONDING DEVICE

(75) Inventor: Masahiko Hori, Kurate-gun (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/717,432

(22) Filed: Mar. 4, 2010

(30) Foreign Application Priority Data
Mar. 11, 2009 (JP) 2009-058750

(51) Int. Cl. B23K 1/20; B23K 3/08

(52) U.S. Cl. 228/102; 228/8

(57) ABSTRACT

The bonding method for fanning a bump on an electrode on a substrate through bonding, includes: making a data storage part store a bonding position coordinate and an assumed bump-bonding area at the bonding position coordinate; recognizing a bondable area of the electrode by shooting an image of the electrode and processing the image; calculating overlap rate between the recognized bondable area and the assumed bump-bonding area stored in the data storage part; determining whether or not the calculated overlap rate is equal to or greater than a set value; and performing bonding on the bonding position coordinate when the overlap rate is determined to be equal to or greater than the set value. The bonding can be performed without being affected by the quality of finish of the electrode pads, and it is possible to avoid a bonding failure at flip-chip bonding and the like.

### CROSS-REFERENCE TO RELATED APPLICATIONS

This application is based upon and claims the benefit of priority from the prior Japanese Patent Application No. 2009-58750 filed on Mar. 11, 2009; the entire contents of which are incorporated herein by reference.

### BACKGROUND OF THE INVENTION

As a semiconductor device capable of realizing a high density mounting, there is known a semiconductor device formed by flip-chip bonding semiconductor chips to electrodes on a mounting board such as a multilayer wiring board. For example, the flip-chip bonding is performed in a manner that Au bumps (stud bumps) are formed on electrode pads of a mounting board through a ball bonding method, and electrode pads on a semiconductor chip side are bonded to the bumps via solders and the like.

In order to correct bonding positions (coordinates) in formation of the bumps (stud bumps) using the ball bonding method, there has been conventionally adopted a method in which position matching between electrode pads being bonding targets and set values of bonding coordinates corresponding to the electrode pads is performed using position matching patterns formed on four corners of the mounting board.

Specifically, in a teaching process, reference points of coordinates and set values of bonding position coordinates are first formed, and reference points of the substrate and the reference points of the coordinates are then matched within an arbitrary allowable range to perform correction for shifting the bonding position coordinates in an X-axis direction and/or a Y-axis direction, rotating, or extending or reducing the coordinates, to thereby match the set values of the bonding position coordinates and the electrode pads being the bonding targets. At this time, in order to correct an error (displacement) between the bonding target electrode pads and the set values of the boding position coordinates caused by a positional accuracy at the time of forming patterns of the electrode pads on the substrate, a the mal expansion of the substrate and the like, the actual bonding target electrode pads are shot by a camera and image processing is conducted. Further, the teaching is performed to correct the set values of the bonding position coordinates so that they match center coordinates of the bonding target electrode pads formed based on the obtained image.

Subsequently, at the time of bonding, the reference points of the substrate set in the teaching process are image-recognized to tentatively match the bonding coordinates, and thereafter, the bonding target electrode pads are shot by the camera to perform image processing in the same manner as in the time of teaching, and the bonding coordinates are corrected so that they match the center coordinates of the bonding target electrode pads formed based on the obtained image. Ball bonding is performed on thus corrected bonding position coordinates to form bumps.

As described above, in the conventional correction of the bonding positions, the electrode pads to be the bonding targets are individually detected, and the bonding position coordinates are corrected so as to match the coordinates to formation positions of the detected and recognized actual bonding target electrode pads, so that the positions (coordinates) on which the bumps are finally formed through the ball bonding are different from the previously set bonding coordinates.

In a next flip-chip bonding process, conductive bonding members (solder balls and the like) formed on a semiconductor chip side based on the previously set bonding position coordinates are bonded to the bumps (stud bumps) formed through the ball bonding as described above, so that a large positional displacement occurs between the bumps and the bonding members such as the solder balls, which sometimes led to a continuity failure.

In order to prevent such a continuity failure, it can be considered to form the bumps without correcting the bonding positions, but, with such a method, the positional displacement at the time of forming the bumps becomes large, and a bonding area cannot be secured depending on a width of the electrode pad. Accordingly, failures such as a bonding failure of the bumps on the electrode pads and a displacement error of the bumps are occurred (for instance, refer to JP-A 05-315389 (KOKAI)).

### BRIEF SUMMARY OF THE INVENTION

A bonding method according to a first aspect of the present invention being a bonding method for forming a bump on an electrode on a substrate through bonding, the bonding method comprises: inputting data to make a data storage part store set coordinate of a bonding position and a bonding area of the bump assumed at the bonding position coordinate; recognizing a bondable area of the electrode by shooting the electrode and processing the shot image; calculating a overlap rate between the recognized bondable area of the electrode and the bonding area of the bump stored in the data storage part; determining whether or not the calculated overlap rate is equal to or greater than a predetermined set value; and bonding to form the bump at the bonding position coordinate when the overlap rate is determined to be equal to or greater than the set value in the determining.

A bonding device according to a second aspect of the present invention being a bonding device for forming a bump on an electrode on a substrate through bonding, the bonding device comprises: a data storage part storing a set coordinate of a bonding position and a bonding area of the bump assumed at the bonding position coordinate; an image processing section shooting an image of the electrode and processing the shot image to recognize a bondable area of the electrode; a calculation processing part calculating a overlap rate between the recognized bondable area of the electrode and the bonding area of the bump stored in the data storage part and determining whether or not the calculated overlap rate is equal to or greater than a predetermined set value; a correction processing part correcting the bonding position coordinate to make the calculated overlap rate equal to or greater than the predetermined set value; and a bonding mechanism performing bonding on the bonding position coordinate.

### BRIEF DESCRIPTION OF THE DRAWINGS

FIG. 1 is a view showing a structure of a bonding device according to the present invention.

FIG. 2 is a flow chart showing process steps of teaching processing in a first embodiment of the present invention.

FIG. 3 is a flow chart showing a bonding method in the first embodiment of the present invention.

FIG. 4 is a plan view showing an overlapping of electrode pads and assumed bump-bonding areas on a substrate before correction of bonding positions in the first embodiment of the present invention.

FIG. 5 is a plan view showing an overlapping of the electrode pads and the assumed bump-bonding areas after the correction of bonding positions in the first embodiment of the present invention.

FIG. 6 is a flow chart showing a bonding method in a second embodiment of the present invention.

FIG. 7 is a plan view showing an overlapping of electrode pads and assumed bump-bonding areas before correction of bonding positions in the second embodiment of the present invention.

FIG. 8 is a plan view showing an overlapping of the electrode pads and the assumed bump-bonding areas after the correction of bonding positions in the second embodiment of the present invention.

FIG. 9 is a flow chart showing a bonding method in a third embodiment of the present invention.

FIG. 10 is a plan view showing an overlapping of electrode pads and assumed bump-bonding areas before correction of bonding positions in the third embodiment of the present invention.

FIG. 11 is a plan view showing an overlapping of the electrode pads and the assumed bump-bonding areas after correction in which extension/reduction correction and X, Y, θ correction are combined is performed in the third embodiment of the present invention.

FIG. 12 is a plan view showing an A portion in FIG. 11 in an enlarged manner for explaining a method for performing individual correction in the third embodiment of the present invention.

### DETAILED DESCRIPTION OF THE INVENTION

Hereinafter, embodiments for carrying out the present invention will be described. Note that although the embodiments will be described based on the drawings in the following description, the drawings are given for the purpose of illustration and explanation, and thus do not limit the present invention.

### First Embodiment

A first embodiment of a bonding method according to the present invention is carried out using a device described below.

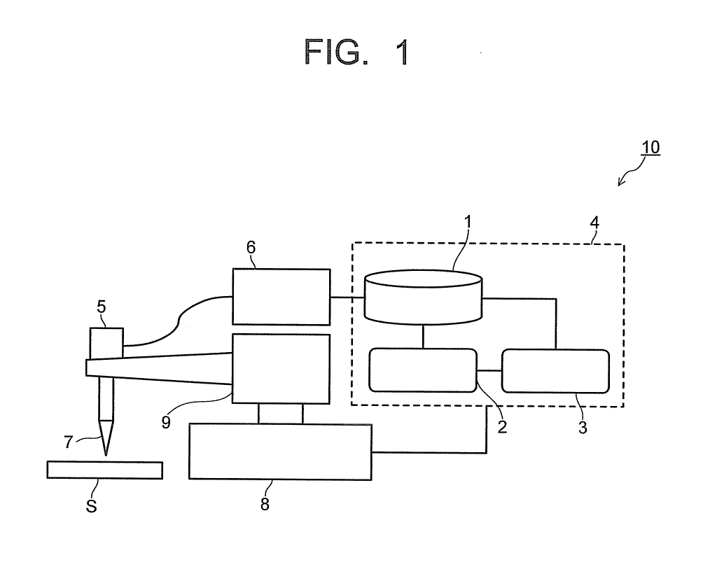

A bonding device 10 shown in FIG. 1 includes a bonding position correcting device provided with a control section 4 having a data storage part 1, a calculation processing part 2, and a correction processing part 3, an image shooting section 5, and an image processing section 6. Further, the bonding device 10 includes a bonding stage S on which a substrate is put, a bump bonding tool 7, an XY table 8 that drives the bump bonding tool 7, and a mechanism 9 that drives the XY table 8.

The data storage part 1 stores various data including predetermined set bonding position coordinates to be bonding targets (hereinafter, referred to as target bonding coordinates), coordinates of reference points of the target bonding coordinates, and bonding areas of bumps assumed at the target bonding coordinates.

The image shooting section 5 shoots electrode pads to be bonding targets. The image processing section 6 processes an image shot by the image shooting section 5, and recognizes and detects bondable areas of the electrode pads. The image shooting section 5 can be united with the image processing section 6.

The calculation processing part 2 calculates, based on the data on the bump-bonding area assumed at the target bonding coordinates (assumed bump-bonding area) and the bondable area of the electrode pad recognized and detected in the image processing section 6, an overlap rate between the areas. Here, the overlap rate is set as a rate of an area of overlapping portion between the assumed bump-bonding area and the bondable area with respect to an area of the assumed bump-bonding area. The calculation processing part 2 determines whether or not the calculated overlap rate is equal to or greater than a predetermined set value.

The correction processing part 3 corrects the bonding positions so that the values of overlap rate calculated in the calculation processing part 2 become equal to or greater than the set value. The correction of the bonding positions is performed by correcting the target bonding coordinates. Further, based on the corrected bonding position coordinates, the bumps (stud bumps) are formed on the electrode pads on the substrate through ball bonding. Specifically, the corrected bonding position coordinates are input to the XY table 8 that drives the bump bonding tool 7, and the ball bonding is performed on the corrected positions.

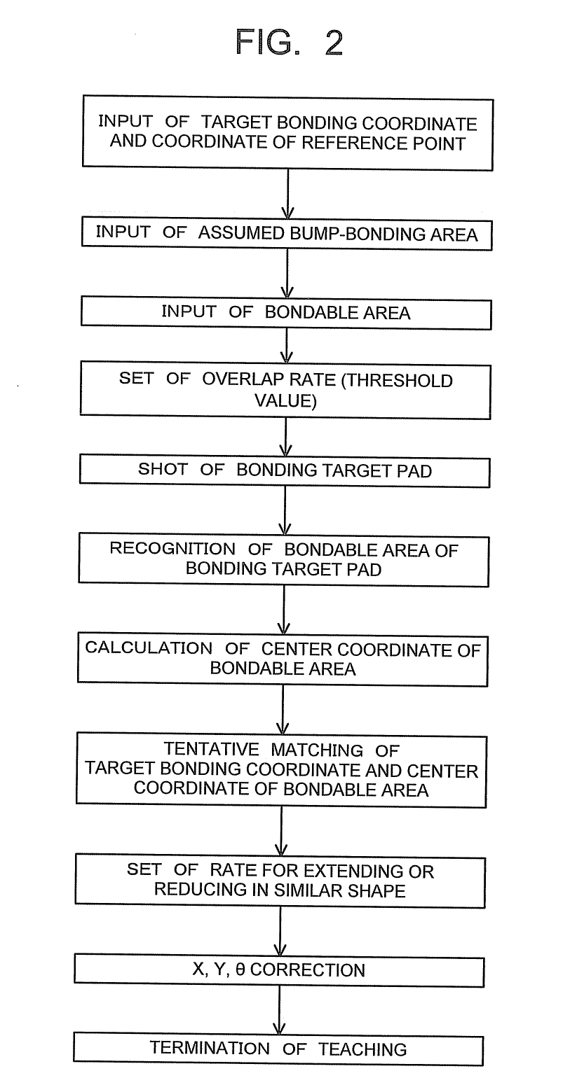

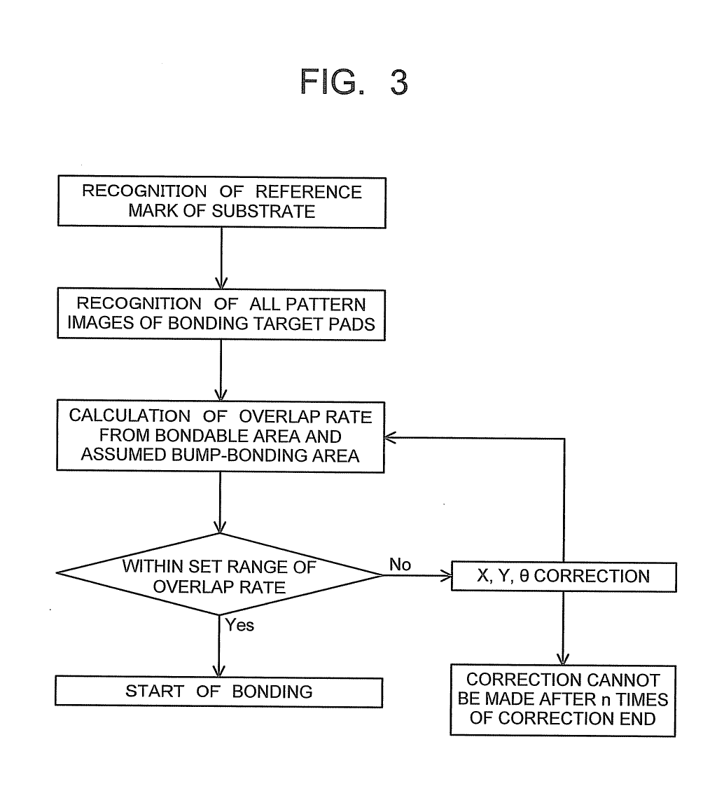

In the first embodiment, teaching processing is performed on a first substrate, and thereafter, the correction of bonding positions (coordinates) is performed on a second and subsequent substrates based on the teaching, and the ball bonding is performed on the corrected positions (coordinates). FIG. 2 shows a flow chart of the teaching processing, and FIG. 3 shows a flow chart of the bonding.

In the teaching processing, the target bonding coordinates and the coordinates of the reference points of the target bonding coordinates are input to the data storage part 1 via an input device (illustration is omitted), as shown in FIG. 2.

Next, a size (area) of a bump virtually assumed at the target bonding coordinate is input to the data storage part 1 as an assumed bump-bonding area. Further, a size (area) of an electrode pad on which the bonding is performed (hereinafter, referred to as a bonding target pad) is input as a bondable area.

Subsequently, a threshold value of overlap rate being a rate of an area of overlapping portion between the assumed bump-bonding area and the bondable area is set, and the value is input to the data storage part 1. The threshold value of the overlap rate can be set to 50%, for instance, but, more preferably, it is set to 70%.

Next, the first substrate is transferred to the ball bonding device, and the reference point of the coordinate is matched to reference point of the substrate through alignment. Further, tentative matching between the electrode pads on which the bonding is actually performed (bonding target pads) and the target bonding coordinates is conducted. In the tentative matching, after the bonding target pads are shot by the image shooting section 5, the image processing is performed by the image processing section 6, and a bondable area of each of the bonding target pads is recognized and detected. Further, center coordinate of the bondable area is calculated. The center coordinate of the bondable area and the target bonding coordinate is then tentatively matched.

Subsequently, a range of magnification of extension or reduction described below is set. Specifically, in the later-described correction of bonding positions after the teaching, in order to make the values of overlap rate between the bondable areas and the assumed bump-bonding areas of all the electrode pads on the substrate equal to or greater than the predetermined set threshold value (for instance, 50%, preferably 70%), the correction for extending or reducing each of the target bonding coordinates in a similar shape around an origin of the coordinate system is sometimes performed (second embodiment). When such an extension or reduction correction is performed, an upper limit value of extension magnification or a lower limit value of reduction magnification is set so that conductive bonding members (solder balls and the like) disposed on a semiconductor chip side are fully positioned and bonded to bumps bonded to positions on which the extension or reduction correction is performed, in a flip-chip bonding process performed after bonding the bumps.

Thereafter, X, Y, θ correction described below is performed according to need, and the teaching is terminated. In the X, Y, θ correction at the time of teaching, at least either of correction in which the entire coordinate system is shifted in an X-axis direction and/or a Y-axis direction and correction in which the entire coordinate system is rotated by θ around the origin thereof is performed while maintaining mutual (relative) positional relationship among the target bonding coordinates, so that the values of overlap rate between the bondable areas and the assumed bump-bonding areas of all the electrode pads on the first substrate become equal to or greater than the predetermined set threshold value (for instance, 50%, preferably 70%). Note that when the values of overlap rate of all the electrode pads on the first substrate are equal to or greater than the set threshold value, the teaching is terminated without performing the X, Y, θ correction.

When the X, Y, θ correction is performed through the teaching as described above, the corrected target bonding coordinates are input to the data storage part 1 as target bonding coordinates after the teaching. Further, the previously stored target bonding coordinates are corrected and are stored to the data storage part 1 as new target bonding coordinates.

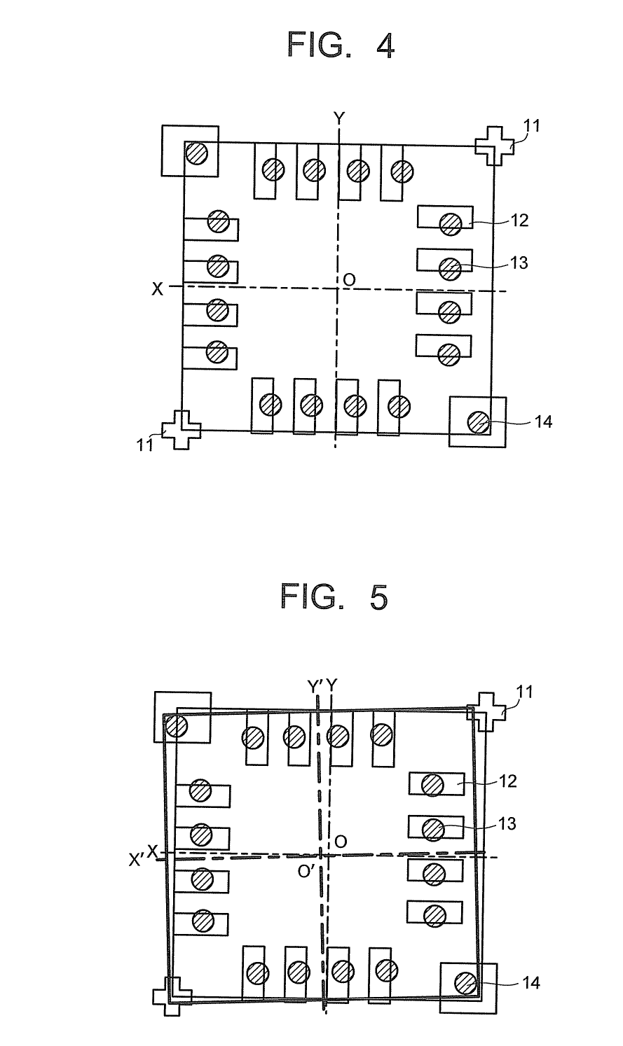

In the first embodiment, the bonding is conducted as described below in accordance with a flow chart shown in FIG. 3. Overlapping states of electrode pads and assumed bump-bonding areas before and after the correction of bonding positions are respectively shown in FIG. 4 and FIG. 5. In FIG. 4 and FIG. 5, a reference numeral 11 denotes a reference mark of substrate, and a reference numeral 12 denotes a bonding target pad. Further, a reference numeral 13 denotes an assumed bump-bonding area at a target bonding coordinate, and a reference numeral 14 denotes a bonding area of bump for position detection at the time of flip-chip bonding.

At first, the substrate is transferred, the reference marks 11 of the substrate are recognized through image recognition, the entire substrate is then shot by the image shooting section to perform image processing in the image processing section, and bondable areas of the respective bonding target pads 12 are recognized and detected, as shown in FIG. 4. Further, center coordinates of the bondable areas are calculated.

Subsequently, an overlap rate between thus recognized and detected bondable area and the assumed bump-bonding area 13 at the target bonding coordinate stored in the data storage part is calculated in the calculation processing part. Further, it is determined to be acceptable if the calculated values of overlap rate of all the bonding target pads 12 are equal to or greater than the predetermined set threshold value of overlap rate (for instance, 50%, more preferably 70%), and the ball bonding is started.

When there exists the bonding target pad 12 in which the calculated value of overlap rate is less than the threshold value, the X, Y, e correction described below is conducted. As shown in FIG. 5, in the X, Y, θ correction, at least either of correction in which the entire coordinate system is shifted in the X-axis direction and/or the Y-axis direction and correction in which the entire coordinate system is rotated by θ around the origin thereof is performed with respect to all the bonding target pads 12 in a state of maintaining mutual positional relationship among the bonding coordinates.

When the values of overlap rate of all the bonding target pads 12 become equal to or greater than the threshold value by repeatedly conducting such X, Y, θ correction, the correction of bonding positions is terminated and the ball bonding is started. When there exists even one bonding target pad 12 in which the value of overlap rate is less than the threshold value even after repeatedly conducting the X, Y, θ correction n times (five times, for instance), it is determined that the correction cannot be made, and the process is designed not to proceed to the ball bonding process.

In the correction shown in FIG. 4 and FIG. 5, the overlap rate of 70% or greater is achieved in all the bonding target pads 12 by shifting the entire coordinate system to minus (−) side of the X-axis and rotating the system counterclockwise by θ. Note that in FIG. 4 and FIG. 5, a coordinate frame before the correction is indicated by a thin line, and a coordinate frame after the correction is indicated by a thick line. Further, X, Y and O respectively indicate an X-axis, a Y-axis and an origin before the correction, and X′, Y′ and O′ respectively indicate an X-axis, a Y-axis and an origin after the correction.

According to the first embodiment structured as above, the positions on which the bumps are ball-bonded on the electrode pads on the substrate are corrected in all the bonding target pads so as to secure sufficient bonding areas, so that it is possible to achieve preferable bonding without being affected by a difference of formation positions of individual electrode pads, and to prevent failures such as a bonding failure and a displacement error of bumps. Further, since the correction of bonding positions is conducted with respect to all the bonding target pads without changing the relative positional relationship among the bonding position coordinates, the positional displacement does not occur at the time of flip-chip bonding between the bumps formed on the substrate side and the bonding members such as solder balls formed on the semiconductor chip side, which enables to prevent the bonding failure.

Next, a second and a third embodiment of the present invention will be described.

### Second Embodiment

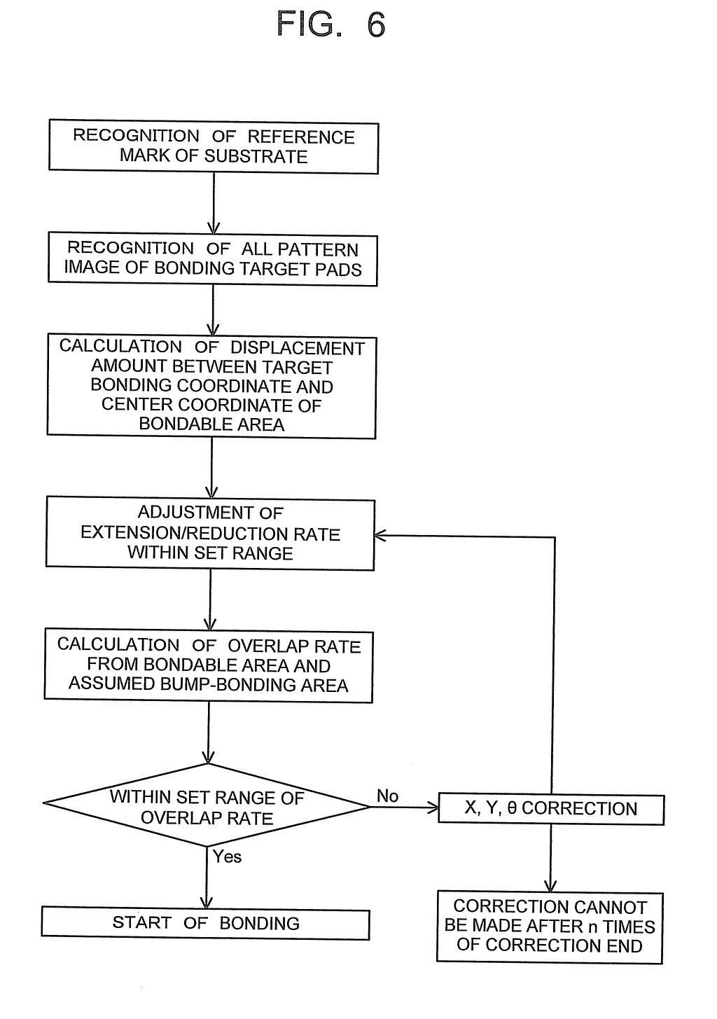

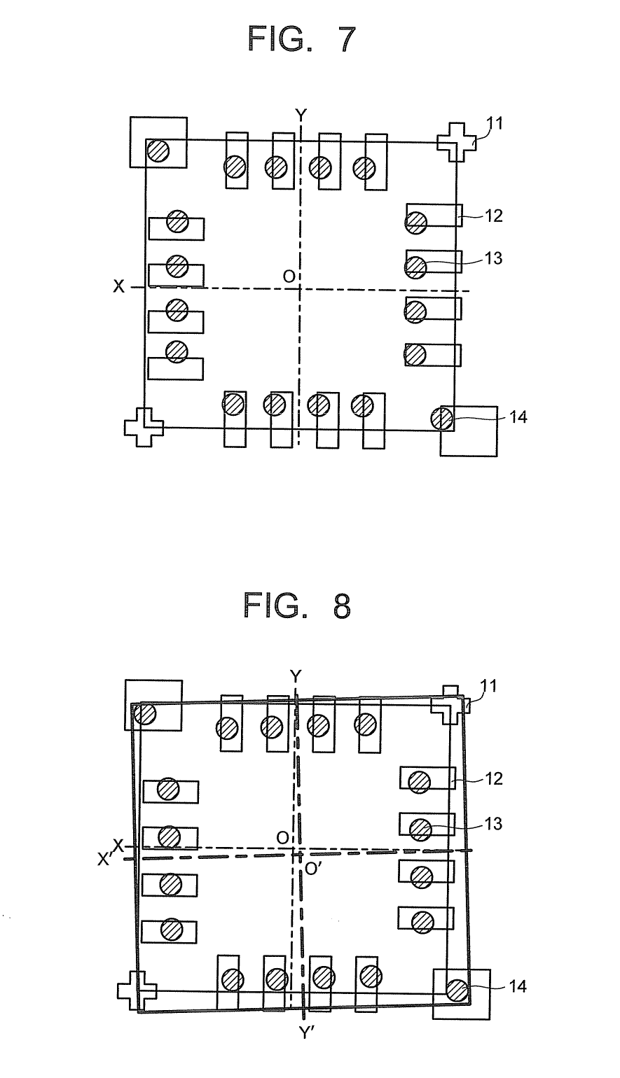

In the second embodiment, the bonding device 10 structured in the same manner as in the first embodiment is used. Further, similar to the first embodiment, the teaching processing is conducted in accordance with the flow chart shown in FIG. 2, and thereafter, the bonding is performed in accordance with a flow chart shown in FIG. 6. Overlapping states of electrode pads and assumed bump-bonding areas before and after the correction of bonding positions are respectively shown in FIG. 7 and FIG. 8. In FIG. 7 and FIG. 8, the same parts as in FIG. 4 and FIG. 5 are denoted by the same reference numerals, and an explanation thereof will be omitted.

In the second embodiment, the reference marks 11 of the substrate are image-recognized, the entire substrate is then shot by the image shooting section to perform image processing in the image processing section, and bondable areas of the respective bonding target pads 12 are recognized and detected. Further, center coordinates of the bondable areas are calculated.

Subsequently, a displacement amount between thus calculated center coordinate of the bondable area and the target bonding coordinate is estimated. Further, when it is determined that, based on the estimated displacement amount, the target bonding coordinates of all the bonding target pads 12 are uniformly displaced in a direction toward an origin of the coordinate system or in a direction toward the outside with respect to the center coordinates of the bondable areas as shown in FIG. 7, the correction for extending or reducing the target bonding coordinates in a similar shape around the origin of the coordinate system is performed within the range of magnification of extension or reduction set at the time of teaching, as shown in FIG. 8.

Next, an overlap rate between the assumed bump-bonding area 13 at the bonding position coordinate after the extension or reduction correction is performed as described above and the previously recognized and detected bondable area is calculated in the calculation processing part. Further, it is determined to be acceptable if the calculated values of overlap rate of all the bonding target pads 12 are equal to or greater than the predetermined set threshold value (for instance, 50%, more preferably 70%), and the ball bonding is started.

When there exists the bonding target pad 12 in which the calculated value of overlap rate is less than the threshold value, the X, Y, θ correction is conducted. As shown in FIG. 8, in the X, Y, θ correction, at least either of correction in which the entire coordinate system is shifted in the X-axis direction and/or the Y-axis direction and correction in which the entire coordinate system is rotated by θ around the origin thereof is performed with respect to all the bonding target pads 12 in a state of maintaining relative positional relationship among the mutual bonding coordinates.

Correction in which such X, Y, B correction and the above-described extension or reduction correction are combined is repeatedly conducted. When the values of overlap rate of all the bonding target pads 12 become equal to or greater than the threshold value, the correction of bonding positions is terminated and the ball bonding is started. When there exists even one bonding target pad 12 in which the value of overlap rate is less than the threshold value even after repeatedly performing n times of correction in which the X, Y, θ correction and the extension or reduction correction are combined, it is determined that the correction cannot be made, and the process is designed not to proceed to the ball bonding process.

In the correction shown in FIG. 7 and FIG. 8, the overlap rate of 70% or greater is achieved in all the bonding target pads 12 by extending the coordinate system at a magnification of 5% or less around the origin of the system, and thereafter, shifting the entire coordinate system to minus (−) side of the X-axis and rotating the system counterclockwise by θ.

According to the second embodiment structured as above, when the target bonding coordinates are uniformly displaced in a direction toward the origin of the coordinate system or in a direction toward the outside with respect to the center coordinates of the bondable areas, it is possible to achieve preferable bonding by minimizing failures such as a bonding failure and a displacement error of bumps. Further, it is possible to prevent the positional displacement at the time of flip-chip bonding between the bumps and the bonding members such as solder balls formed on the semiconductor chip side, which enables to avoid the bonding failure.

### Third Embodiment

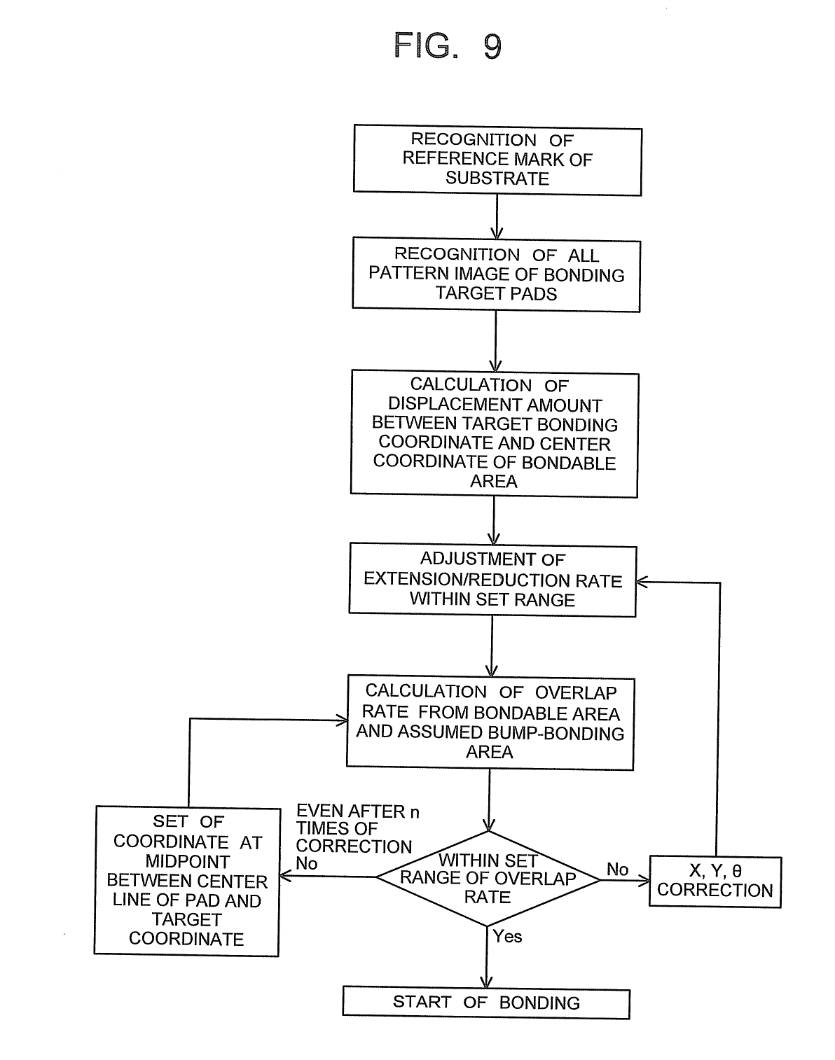

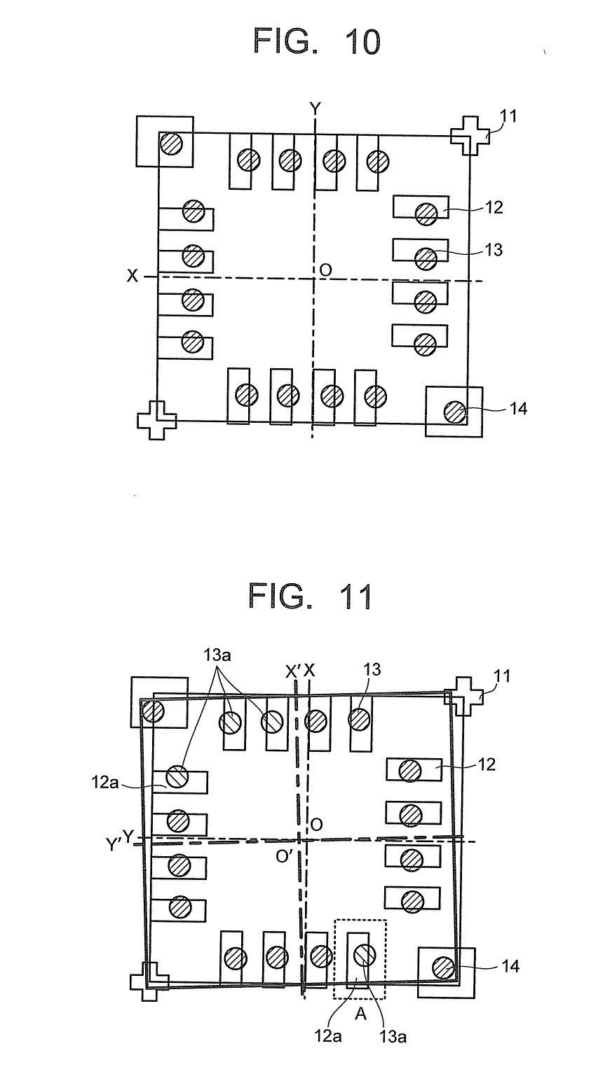

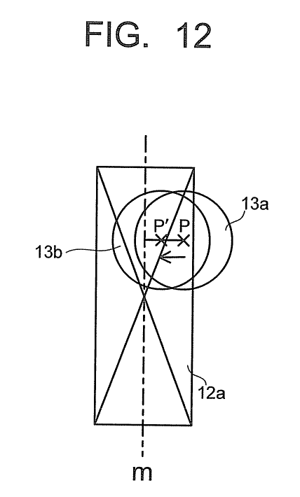

In the third embodiment, the bonding device 10 structured in the same manner as in the first and second embodiments is used. Further, similar to the first embodiment, the teaching processing is conducted in accordance with the flow chart shown in FIG. 2, and thereafter, the bonding is performed in accordance with a flow chart shown in FIG. 9. An overlapping state of electrode pads and assumed bump-bonding areas before the correction of bonding positions is shown in FIG. 10. Further, overlapping states of the electrode pads and the assumed bump-bonding areas after the correction are shown in FIG. 11 and FIG. 12.

In the teaching processing in the third embodiment, the threshold value of overlap rate and an allowable number of bonding target pads (bonding-failure pads) having the overlap rate less than the threshold value are set, and each of the values is input to the data storage part 1.

In the bonding process, the reference marks 11 of the substrate are first image-recognized, the entire substrate is then shot by the image shooting section to perform image processing in the image processing section, and bondable areas of the respective bonding target pads 12 are recognized and detected. Further, center coordinates of the bondable areas are calculated. Further, a virtual line (center line (m)) passing through a center of the recognized and detected bondable area is drawn, and the center line (in) is recognized and stored in the data storage part 1. The center line (m) can be freely set in accordance with a shape of the bondable area. In this embodiment, since the shape of the bondable area is rectangle as shown in FIG. 12, a straight line connecting midpoints of short sides of the rectangle, namely, a line passing through an intersection of diagonal lines and being parallel to a longitudinal direction, is set as the center line (in).

Subsequently, a displacement amount between the calculated center coordinate of the bondable area and the target bonding coordinate is estimated. Further, based on the estimated displacement amount, the correction for extending or reducing the target bonding coordinates in a similar shape around the origin of the coordinate system is performed according to need within the range of magnification of extension or reduction set at the time of teaching. The extension or reduction correction is not performed except when the target bonding coordinates are determined to be uniformly displaced in a direction toward the origin of the coordinate system or in a direction toward the outside with respect to the center coordinates of the bondable areas.

Next, an overlap rate between the assumed bump-bonding area 13 at the bonding position coordinates after the extension or reduction correction is performed according to need and the previously recognized and detected bondable area is calculated in the calculation processing part. Further, it is determined to be acceptable if the calculated values of overlap rate of all the bonding target pads 12 are equal to or greater than the predetermined set threshold value (for instance, 50%, more preferably 70%), and the ball bonding is started.

When there exists the bonding target pad 12 in which the calculated value of overlap rate is less than the threshold value, the X, Y, θ correction is conducted. As shown in FIG. 11, in the X, Y, θ correction, at least either of correction in which the entire coordinate system is shifted in the X-axis direction and/or the Y-axis direction and correction in which the entire coordinate system is rotated by θ around the origin thereof is performed with respect to all the bonding target pads 12 in a state of maintaining relative positional relationship among the mutual bonding coordinates. Correction in which such X, Y, θ correction and the above-described extension or reduction correction are combined is repeatedly conducted. When the values of overlap rate of all the bonding target pads 12 become equal to or greater than the threshold value, the correction of bonding positions is terminated and the ball bonding is started.

When there exist bonding-failure pads 12a having the value of overlap rate less than the threshold value even after repeatedly performing n times of correction in which the X, Y, θ correction and the extension or reduction correction are combined, the number of the pads is calculated, and if the number is within the set range of allowable number, individual correction described below is performed only on the bonding-failure pads 12a. An assumed bump-bonding area in the bonding-failure pad 12a is denoted by a reference numeral 13a. The individual correction is not performed on the bonding target pads 12 having the overlap rate equal to or greater than the threshold value. If the number of bonding-failure pads 12a is greater than the allowable value, it is determined that the correction cannot be made, and the process does not proceed to the ball bonding process.

As shown in FIG. 12 in an enlarged manner, in the individual correction of the bonding-failure pad 12a, there is performed correction in which target bonding coordinate P is shifted by an arbitrary length on a line segment (perpendicular line) dropped from the coordinate to the center line (m) set on the bondable area of the bonding-failure pad 12a. Note that an assumed bump-bonding area after the individual correction is denoted by a reference numeral 13b. Further, target bonding coordinate after the individual correction is set as P′. As described above, also the value of overlap rate of the bonding-failure pad 12a can be increased to be equal to or greater than the threshold value. The length by which the target bonding coordinate is shifted can be freely set, and can be set to ½ of a distance from the target bonding coordinate P to the center line (m), for instance. Specifically, it is possible to conduct the correction in which the target bonding coordinate P is shifted to a midpoint of the line segment (perpendicular line).

According to the third embodiment structured as above, when there exists the bonding-failure pad 12a in which the value of overlap rate becomes less than the threshold value even after repeatedly performing n times of correction in which the X, Y, θ correction and the extension or reduction correction are combined, the correction is individually performed only on such a bonding-failure pad 12a, to thereby achieve the overlap rate equal to or greater than the threshold value. Therefore, it is possible to further prevent the bonding failure of bumps, compared to the first and second embodiments.

The structure, shape, size and positional relation described in the above embodiments are only schematically indicated and the compositions (materials) of components are just illustrative. Accordingly, the present invention is not limited to the above embodiments, and can be modified in various forms as long as they do not depart from the scope of the technical spirit as set forth in claims.

What is claimed is:

1. A bonding method for forming a bump on an electrode on a substrate through bonding, comprising:
inputting data to make a data storage part store set coordinate of a bonding position and a bonding area of the bump assumed at the bonding position coordinate;
recognizing a bondable area of the electrode by shooting the electrode and processing the shot image;
calculating a overlap rate between the recognized bondable area of the electrode and the bonding area of the bump stored in the data storage part;
determining whether or not the calculated overlap rate is equal to or greater than a predetermined set value; and
bonding to form the bump at the bonding position coordinate when the overlap rate is determined to be equal to or greater than the set value in the determining.

2. The bonding method according to claim 1,
wherein the data inputting comprises inputting the set value (threshold value) of the overlap rate to the data storage part.

3. The bonding method according to claim 1,
wherein the recognizing comprises recognizing a reference mark of the substrate by shooting the mark and processing the shot image.

4. The bonding method according to claim 1,
wherein the bonding comprises forming the bump at the bonding position coordinate when the overlap rates of all electrodes to be bonding targets on the substrate are determined to be equal to or greater than the set value in the determining.

5. The bonding method according to claim 1, further comprising,
correcting, when the overlap rate is determined to be less than the set value in the determining, the bonding position coordinate to make the overlap rate equal to or greater than the set value.

6. The bonding method according to claim 5,
wherein the correcting comprises performing X, Y, θ correction to shift and/or rotate the entire coordinate system in a state of maintaining relative positional relationship among a plurality of the bonding position coordinates.

7. The bonding method according to claim 5,
wherein the correcting comprises extending or reducing the bonding position coordinate around an origin of the coordinate system.

8. The bonding method according to claim 6,
wherein the correcting comprises performing the X, Y, θ correction after extending or reducing the bonding position coordinate around the origin of the coordinate system.

9. The bonding method according to claim 6,
wherein the X, Y, θ correction is repeatedly conducted in the correcting.

10. The bonding method according to claim 7,
wherein the data inputting comprises inputting, to the data storage part, a range of magnification for extending or reducing the bonding position coordinate around the origin of the coordinate system in the correcting.

11. The bonding method according to claim 5,
wherein the calculating comprises calculating center coordinate of the bondable area of the electrode and estimating a displacement amount between the center coordinate and the bonding position coordinate.

12. The bonding method according to claim 11, further comprising,
determining, based on the estimated displacement amount, a uniform displacement of the bonding position coordinates of all electrodes to be bonding targets on the substrate.

13. The bonding method according to claim 12,
wherein the correction for extending or reducing the bonding position coordinate around the origin of the coordinate system is conducted in the correcting when the displacement is determined to exist in the determining of the displacement.

14. The bonding method according to claim 5,
wherein the correcting comprises individually correcting a bonding position coordinate in which the overlap rate is less than the set value by shifting the bonding position coordinate to an arbitrary point on a line segment connecting a center coordinate or a center line of the bondable area of the electrode and the bonding position coordinate.

15. The bonding method according to claim 14,
wherein the individual correcting comprises shifting the bonding position coordinate to a midpoint of the line segment.

16. The bonding method according to claim 5, comprising,
making the data storage part store, after performing the data inputting, the recognizing, the calculating, the determining, and the correcting on a first substrate, the bonding position coordinate corrected in the correcting as the bonding position coordinate set with respect a second and subsequent substrates.

17. The bonding method according to claim 5,
Where the data inputting comprises inputting, to the data storage part, an allowable number of bonding-failure electrodes having the overlap rate less than the set value.

18. The bonding method according to claim 17,
wherein when the number of electrodes in which the overlap rate becomes less than the set value even after performing the correction a predetermined number times is equal to or less than the allowable number, individual correction is performed only on the bonding-failure electrode by shifting the bonding position coordinate to an arbitrary point on a line segment connecting a center coordinate or a center line of the bondable area of the electrode and the bonding position coordinate.

19. The bonding method according to claim 5,
Where the bonding is not performed when there is an electrode in which the overlap rate becomes less than the set value even after repeatedly conducting the correction a predetermined number of times.

20. A bonding device for forming a bump on an electrode on a substrate through bonding, comprising:
a data storage part storing a set coordinate of a bonding position and a bonding area of the bump assumed at the bonding position coordinate;
an image processing section shooting an image of the electrode and processing the shot image to recognize a bondable area of the electrode;
a calculation processing part calculating a overlap rate between the recognized bondable area of the electrode and the bonding area of the bump stored in the data storage part and determining whether or not the calculated overlap rate is equal to or greater than a predetermined set value;
a correction processing part correcting the bonding position coordinate to make the calculated overlap rate equal to or greater than the predetermined set value; and
a bonding mechanism performing bonding on the bonding position coordinate.
